(19) United States
(12) Patent Application Publication
(10) Pub. No.: US 2017/0072795 A1
(43) Pub. Date: Mar. 16, 2017

(54) Diagnosing A Pressure Sensor In A Vehicle Body Structure

(71) Applicant: Ford Global Technologies, LLC, Dearborn, MI (US)

(72) Inventors: Mahmoud Yousef Ghannam, Canton, MI (US); Darren Lee, Brighton, MI (US); Roy Joseph Scott, Saline, MI (US)

(21) Appl. No.: 14/851,681

(22) Filed: Sep. 11, 2015

(51) Int. Cl. B60K 35/00; G01L 19/00

(52) U.S. Cl. CPC B60K 35/00; G01L 19/00

(57) ABSTRACT

A vehicle door is provided with a pressure sensor within a cavity in the door. The pressure sensor is coupled to a processor and is configured to determine the air pressure within the cavity of the door. The vehicle also includes an atmospheric air pressure sensor coupled to the processor. When the door is closed with enough of a force, the air pressure changes within the cavity. During this time, the processor is programmed to receive air-pressure signals from the pressure sensor. The processor recognizes a fault in the pressure sensor if the pressure sensor does not detect a change in air pressure that varies from the atmospheric pressure by more than an expected amount when the door closes.

### TECHNICAL FIELD

The present disclosure relates to a pressure sensor in a vehicle body structure and an associated control and power strategy for diagnosing the pressure sensor.

### BACKGROUND

A restraint system in a vehicle can detect an impact of the vehicle from multiple directions. Based on the direction of the impact, the restraint system may use different sensors to detect the impact. For example, accelerometers may be used to detect a forward or rear collision based on a sudden change in vehicle acceleration. Air pressure sensors may be located within an interior of a vehicle door to detect a side impact based on a sudden change in air pressure in the door. Sudden changes in air pressure detected by the air pressure sensors can trigger a restraint control module to inflate a side airbag.

These air pressure sensors have the potential to output inaccurate pressure readings if the inlet or port of the air pressure sensor is blocked. One potential cause of a blockage in the air pressure sensor port is dirt, bugs, or outside particles being lodged within the housing of the sensor.

### SUMMARY

According to one embodiment, a vehicle comprises an air pressure sensor and a controller coupled to the pressure sensor. The pressure sensor is configured to detect pressure within a door cavity of a door of the vehicle. The controller is programmed to output for display an alert indicating a fault with the pressure sensor in response to door cavity pressures detected by the sensor not varying from atmospheric pressure by more than an expected amount during a door-open or door-close event.

According to another embodiment, a method of diagnosing a sensor by a sensor is provided. The method includes receiving a first signal from a pressure sensor indicating air pressure within a door panel of a vehicle, and receiving a second signal from an atmospheric pressure sensor indicating atmospheric pressure. The method also includes displaying an alert indicating a fault with the pressure sensor in response to air pressure within the door panel not varying from the atmospheric pressure by more than an expected amount during a door-open or door-close event.

In yet another embodiment, a vehicle comprises a door, a door-ajar sensor, and a pressure sensor configured to detect air pressure within the door. A receiver is configured to receive a request from a key fob to start or unlock the vehicle. A controller is programmed to (1) store the air pressure in response to the request, and (2) after a signal change from the door-ajar sensor, issue an alert based on the stored air pressure prior to the signal change.

### BRIEF DESCRIPTION OF THE DRAWINGS

FIG. 1 is a perspective semi-exploded view of a door of a vehicle, illustrating two separate panels disassembled.

FIG. 2 is a perspective view of the assembled door of FIG. 1.

FIG. 3 is a cross-sectional view of a cavity within the panels of the door and an air pressure sensor within the cavity, according to one embodiment.

FIG. 4 is a perspective view of the air pressure sensor of FIG. 3, according to one embodiment.

FIG. 5 is a flowchart of an algorithm performed by a controller to diagnose the air pressure sensor, according to one embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terms “inner,” “outer,” “interior,” and “exterior” are used throughout this disclosure. These terms are intended to bring a directional context to the surroundings of the vehicle door, the door panels, and the air pressure sensor. These terms are meant to give exemplary context of various components relative to the central interior of the vehicle. For example, an “inner panel” is meant to invoke the understanding that that panel is more towards the interior of the vehicle than is a corresponding “outer panel.” These terms (and other similar terms) are not meant to be limiting to the scope of this disclosure whatsoever, but are rather meant to give examples of directional relativity between and amongst various components.

Air pressure sensors are used in many automotive systems, including engine control and safety system. One application of an air pressure sensor is to predict an impact with a side of a vehicle such as a collision with a side door. The side door assembly may be constructed of an inner panel and an outer panel (or exterior panel). A cavity may exist between the inner and outer panel of the door. The cavity may not be air-tight and may include an opening to permit air to pass between the cavity and an outside of the door. This opening may allow a small volume of air to freely pass between the cavity and the outside, to allow the air pressure in the door to match changes in atmospheric pressures. In the event of an impact to the side of the vehicle, such as in a vehicular collision, the rapid deformation of the exterior panel may create a sudden large change in air pressure within the cavity. The opening is typically not large enough to compensate for this sudden large change in air pressure.

The detected air pressure within the cavity by the pressure sensor can trigger a controller to activate side-impact airbags. For example, the air sensor may be configured to measure the pressure in the cavity and output a signal to a controller including a processor, or Restraint Control Module (RCM). The controller may deploy an airbag, such as a side curtain airbag, into a vehicle passenger compartment based on the pressure or the change in pressure measured by the air sensor.

The operator of the vehicle or a technician should be well-informed as to the status of the air pressure sensor, and whether it is outputting accurate pressure readings. According to various embodiments of this disclosure, an automatic, continuously-available diagnostic test can be run on the air pressure sensor without the need for any external equipment or removal of the door panels to inspect the pressure sensor itself.

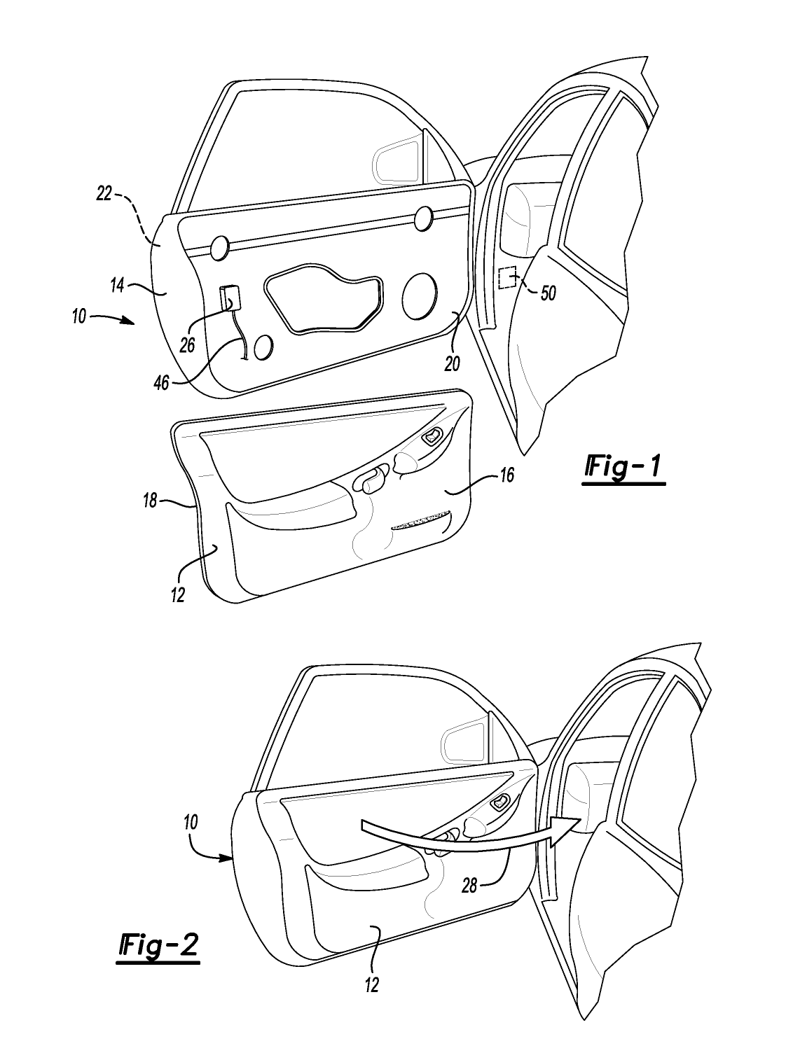

FIG. 1 is a side perspective view of a door assembly 10 illustrating an inside of the door. The door assembly 10 includes an inner door panel 12 (also referred to as a door frame) and an outer door panel 14 (also referred to as an exterior door panel). These panels 12, 14 may be made of steel, or may be made of a lightweight material—such as aluminum alloy, magnesium alloy or composite. The inner panel 12 includes an interior side 16 that faces the cabin and an exterior side 18 that faces the outer panel 14. Likewise, the outer panel 14 includes an interior side 20 that faces the inner panel 12, and an exterior side 22 that faces the environment outside the vehicle. The inner door panel 12 is connected to the outer door panel 14 to define a cavity therebetween. In other words, the cavity is defined by and located between the exterior side of the inner panel 12 and the interior side of the outer panel 14. This cavity will be further described with reference to FIG. 3. In one embodiment, the inner and outer panels 12, 14 are coupled to one another around the outer periphery of the panels.

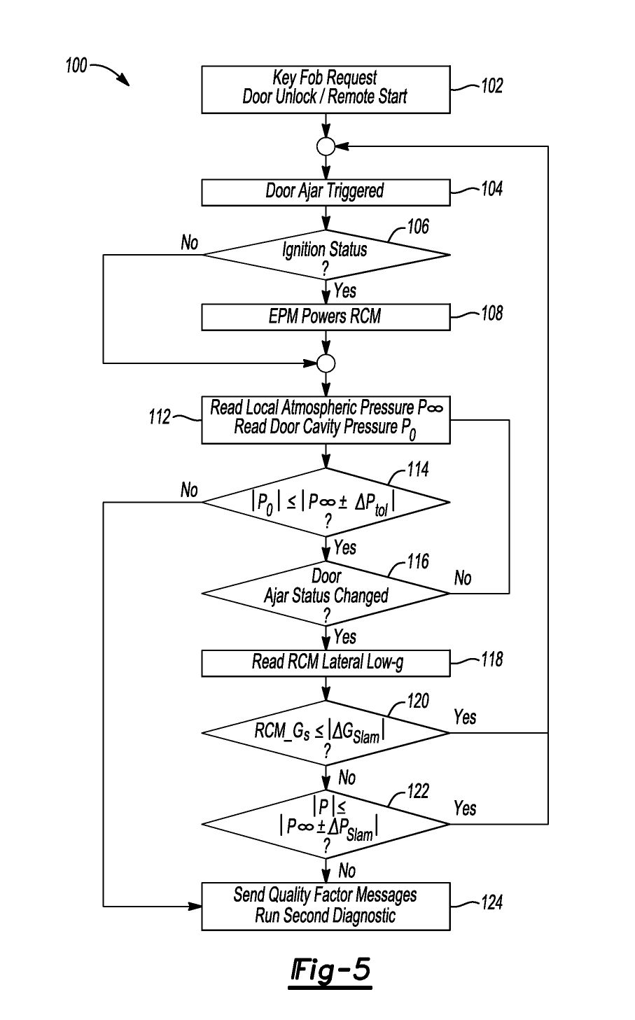

FIG. 1 also illustrates an air pressure sensor 26, which is shown in more detail in FIG. 4. The pressure sensor 26 can be mounted to either the inner or outer door panels, and has an inlet capable of detecting pressure changes within the door and between the panel for deployment of airbags as part of an airbag-deployment safety system.

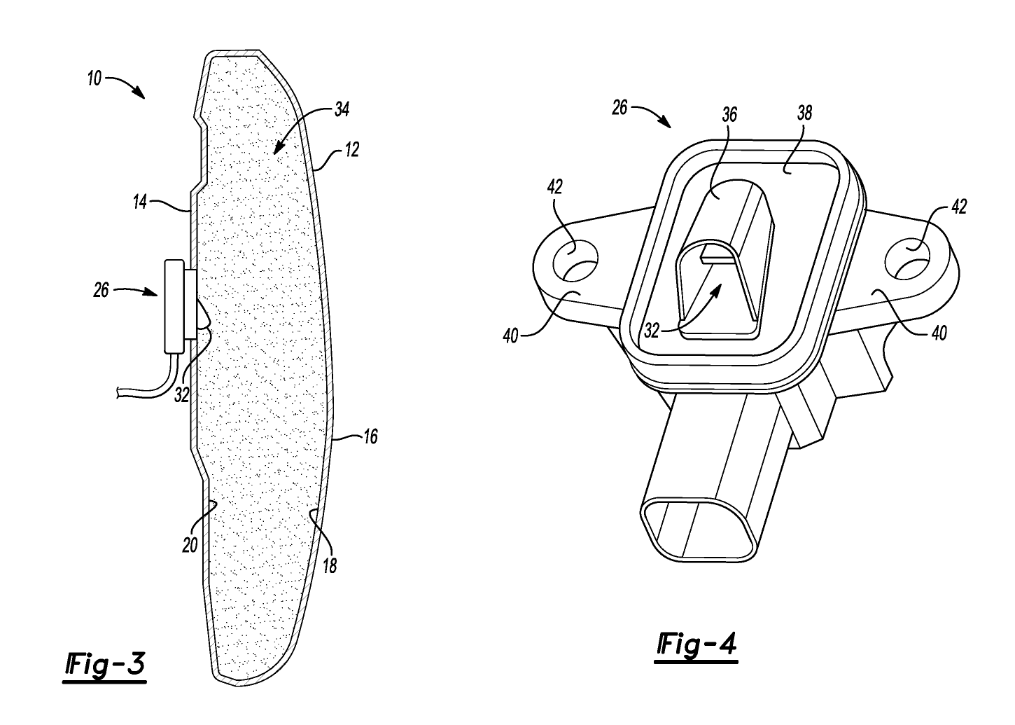

As described above, this disclosure provides an automatic diagnostic test that can be run on the pressure sensor 26. As will be described in more detail below, pressures can be monitored by the pressure sensor 26 while the vehicle door is opening or closing. FIG. 2 illustrates the fully-assembled door assembly 10. Arrow 28 indicates the direction the door closes, toward the vehicle. It is during this time of closing the vehicle door that the diagnostic test of the pressure sensor 26 can be run. The diagnostic procedure described below can also be applied when the vehicle door is opening.

FIG. 3 is a cross-sectional side view of the door assembly 10, illustrating the air pressure sensor 26 having a port or inlet 32. The inlet 32 is disposed within a cavity 34 defined between the inner and outer panels 12, 14. While the pressure sensor 26 is illustrated as being disposed on the outside of the cavity 34 with the inlet protruding into the cavity 34, this is only one embodiment. For example, the pressure sensor 26 may be disposed on the interior side 16 of the inner panel 12 with the air inlet 32 protruding through the inner panel 16 to the cavity 34. Alternatively, the pressure sensor 26 may be disposed on the exterior side 18 of the inner panel 12 with the air inlet 32 and pressure sensor 26 within the cavity 34. Also, the pressure sensor 26 may be disposed on a structure within the cavity 34 supported by either or both of the inner panel 12 or outer panel 14. In any embodiment, however, it is preferred that the inlet 32 of the pressure sensor 26 be disposed in the cavity 34, or at least within some cavity between the inner and outer panels 12, 14.

For additional clarity, FIG. 4 provides a perspective view of one embodiment of the air pressure sensor 26. The air inlet 32 is provided within a shield extending from a planar surface 38. Flanges 40 are provided with apertures 42 to receive fasteners to mount the pressure sensor 26 to one of the panels 12, 14 or structure within the cavity 34. As the door is closed shut (again, as illustrated by arrow 28 in FIG. 2), air pressure changes within the cavity 34 relative to atmospheric pressure. This causes a pressure change within the air inlet 32 and a sensed pressure change by pressure sensor 26. Electrical signals carrying data regarding the change in air pressure are sent via wires 46 to a controller within the vehicle. The data can be processed by a specifically-programmed processor, such as processor or controller 50 (FIG. 1), to run a diagnostic algorithm such as the one illustrated in FIG. 5. For example, the controller 50 can be a restraint crash module (RCM) that receives signals from the pressure sensor 26 and other crash sensors to determine if there has been a collision, and is specifically programmed to deploy airbags and accomplish other safety measures in response to receiving data from those sensors.

FIG. 5 is an exemplary algorithm 100 programmed onto a processor or controller 50 to run a diagnostic test on the pressure sensor 26 using the data obtained by the pressure sensor 26 regarding the change in pressure in the cavity 34 while the door is being shut. A concept of this algorithm 100 is that the pressure sensor 26 should detect a change in air pressure as the door is being shut closed. For example, tests can be run on the vehicle and a calibrated value of air pressure change during a door-close or door-open event can be stored on memory within the vehicle. These calibrated values are representative of what the pressure change should be while the door is closed or opened at various speeds. To diagnose the air pressure sensor 26, the controller receives the detected air pressure from the pressure sensor 26 and compares the detected air pressure to the calibrated air pressures and/or to atmospheric pressure, as will be further described below.

The algorithm 100 begins at 102. Step 102 represents an exemplary step of determining when to initiate and prepare controllers within the vehicle to run the diagnostic. At 102, a request to unlock the doors or start the engine is received via a wireless receiver within the vehicle from a key fob or other similar device. Based on this received signal, it can be inferred that the driver of the vehicle will soon be entering the vehicle, in which a door-open and door-close event will take place, and hence when a diagnostic test can be run. Also in response to this signal, a battery within the vehicle can initialize power sent to a door-ajar sensor that determines whether the door is open or close.

At 104, subsequent to the request from the key fob, the controller receives a signal that the door has opened. More particularly, a door-ajar sensor is placed at or near the door. This sensor can be a physical locational sensor, radar sensor, or any other known sensor that determines whether the door is ajar or closed. When the signal changes to “ajar,” indicating that the door has changed from being closed to being opened, the method proceeds to 106.

At 106, the ignition status of the vehicle is monitored. If the operator of the vehicle has turned the ignition upon entering the vehicle, or if the request form the key fob was a remote-start request, the algorithm proceeds to 108 in which power modules and control modules are activated. In one particular example, at 108 the battery electronic control module (BECM) or electronics control module (ECM) powers the restraint crash module (RCM) or other such controller. This prepares the controller to receive signals from the pressure sensor 26 to monitor the air pressure within the door.

Once the controller is properly prepared, at 112 the controller receives signals from an atmospheric air pressure sensor mounted to the vehicle. This atmospheric air pressure sensor is configured to determine the atmospheric air pressure (P_{∞}), i.e., the air pressure surrounding the vehicle. This can vary due to changes in elevation, temperature, and other factors. The controller also receives signals from the pressure sensor 26 in the cavity 34 of the door to determine the door cavity pressure (P₀).

At 114, the controller first determines whether the air pressure within the door cavity (P₀) is the same as the local atmospheric air pressure (P_{∞}). If the door is stationary and either opened or closed, the door cavity pressure (P₀) should be the same as the local atmospheric air pressure (P_{∞}). The controller can determine whether the air pressure within the door cavity (P₀) is within some pre-programmable tolerance (ΔPₜₒₗ) from atmospheric pressure. The tolerance can be a pressure value represented as some fraction of atmospheric pressure, and can be pre-programmable based on the vehicle characteristics.

In other words, as represented at 114, it is determined whether |P₀|≦|P_{∞}±ΔPₜₒₗ|. If the door cavity pressure is within the pre-programmable tolerance, the algorithm proceeds to 116. At 116, the controller determines whether a signal change has been received from the door-ajar sensor. A change in signal indicates the door either opening or closing. In one embodiment, the change in signal is a change from door-open to a door-close, indicating that the door has closed. Meanwhile, the controller measures the air pressure changes in the door during this door-close event.

At 118, the controller retrieves the lateral acceleration and g-forces during the door-close event (RCM_G_{S}). This can be determined by receiving signals from velocity sensors in the door, for example. At 120, the controller determines whether the door-close event was of great enough force to cause a pressure change in the door cavity that can be properly analyzed and compared to what would be an expected pressure change. Calibrated g-forces and accelerations (ΔGₛₗₐₘ) during door-close events can be stored in the vehicle's memory or storage, representing what are expected forces during a door-close event. If the acceleration and g-forces signals received while the door is being closed are greater than or equal to the calibrated and stored accelerations and g-forces, the controller infers that the door was shut with enough force that the pressure sensor 26 can be properly diagnosed to read and analyze its pressure changes during the shutting of the door. If the door was not shut with enough force, the algorithm returns.

If the door was shut with a large enough force, the algorithm proceeds to 122 in which the air pressure sensor is diagnosed. Calibrated pressure change ranges (ΔPₛₗₐₘ) departing am, from atmospheric pressure (P_{∞}) during previous door-close events can be stored in the vehicle's memory or storage. These calibrated pressure changes represent what are expected pressure changes from atmospheric air pressure during door-close events. As the door is closed shut, the air pressure is expected to deviate somewhat from atmospheric pressure, and this pressure change is stored in the vehicle's memory or storage as an expected air pressure change from atmospheric air pressure. It is these values that the current pressure change during this particular door-close event is compared to. In particular, at 122, the controller compares the air pressure data (|P₀|) from the pressure sensor 26 during the door-close event to the calibrated expected deviation from atmospheric air pressure (|P_{∞}±ΔPₛₗₐₘ|) during door-close events.

If it is determined at 122 that the air pressure within the door cavity has not altered from (e.g., reduced below) the atmospheric pressure and its calibrated deviation (|P_{∞}±ΔPₛₗₐₘ|), it is inferred that the pressure sensor 26 is not operating properly. This can be due to a blockage or other issues described above. At 124, the controller sends quality factor messages, and runs a second diagnostic to confirm the issue with the pressure sensor 26. At this step, the controller can also cause an alert to be displayed, indicating to the operator or a service technician that there is a fault with the pressure sensor 26. This alert can include a message being displayed on the on-board screen of the vehicle, a light on the dashboard instrument panel, or other known fashions of visually indicating service is needed. The controller can also be connected to an on-board diagnostic (OBD or OBD-II) port; when an OBD (or OBD-II) diagnostic tool is connected to the OBD (or OBD-II) port, the controller can cause the alert to be displayed on the screen of the diagnostic tool to indicate to the technician that the pressure sensor is faulty. In other embodiment, an audio alert played through the speakers indicating to the operator or technician that service to the pressure sensor 26 is advisable.

The controller can also cause this alert to be displayed based on the outcome of the comparison at step 114. As described above, at 114 the controller can determine whether the air pressure within the door cavity (P₀) is within some pre-programmable tolerance (ΔPₜₒₗ) from atmospheric pressure (P_{∞}). If the air pressure within the door cavity (P₀) is not within this tolerance even before the door-ajar status change at 116, then it is inferred that there is a fault with the operation of the pressure sensor, and the alert is displayed.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A vehicle comprising:
a pressure sensor configured to detect door cavity pressures; and
a controller programmed to output for display an alert indicating a fault with the pressure sensor in response to door cavity pressures detected by the sensor not varying from atmospheric pressure by more than an expected amount during a door-open or door-close event.

2. The vehicle of claim 1 further comprising an atmospheric air sensor coupled to the controller and configured to detect the atmospheric pressure.

3. The vehicle of claim 2, wherein the expected amount is a predetermined amount that varies as the atmospheric pressure varies.

4. The vehicle of claim 3 further comprising an on-board computer-readable memory unit coupled to the controller and configured to store data relating to the door cavity pressures detected by the sensor and the atmospheric pressure detected by the atmospheric air sensor.

5. The vehicle of claim 4 further comprising a door-ajar sensor coupled to the controller and configured to determine whether the door is closed or at least partially open, wherein the door-open or door-close event is defined as a change in output from the door-ajar sensor.

6. The vehicle of claim 5, wherein the controller is further programmed to, in response to the door-ajar sensor indicating the door has closed, output for display the alert based on a comparison of stored air pressure within the cavity and stored atmospheric pressure prior to the door being closed.

7. The vehicle of claim 1, wherein the pressure sensor is part of an airbag-deployment system in which an airbag is deployed in response to the door cavity pressures exceeding a threshold.

8. A method of diagnosing a sensor, comprising:
by a controller,
receiving a first signal from a pressure sensor indicating air pressure within a door panel of a vehicle;
receiving a second signal from an atmospheric pressure sensor indicating atmospheric pressure; and
displaying an alert indicating a fault with the pressure sensor in response to air pressure within the door panel not varying from the atmospheric pressure by more than an expected amount during a door-open or door-close event.

9. The method of claim 8, wherein the expected amount is a predetermined amount that varies as the atmospheric pressure varies.

10. The method of claim 8 further comprising
receiving a third signal indicative of a vehicle door being ajar, and
receiving a fourth signal indicative of the vehicle door being closed,
wherein the door-open or door-close event is based on receiving the third or fourth signals.

11. The method of claim 8 further comprising
receiving a third signal from a key fob requesting the vehicle to start or doors of the vehicle to unlock, and
initiating an output of the first signal and the second signal based on the receiving of the third signal.

12. The method of claim 11 further comprising
storing the first and second signals on an on-board computer-readable storage unit in response to the receiving of the third signal,
displaying the alert in response to receiving a fourth signal indicating the vehicle door being closed and the air pressure within the door panel not varying from the atmospheric pressure by more than the expected amount.

13. The method of claim 8, wherein the step of displaying includes illuminating a warning symbol on a dashboard of the vehicle.

14. The method of claim 8, wherein the step of displaying includes sending a pressure-sensor-error signal to an on-board diagnostic (OBD) connector coupled to an OBD port on the vehicle to cause a diagnostic tool to display the alert.

15. A vehicle comprising:
a door;
a door-ajar sensor;
a pressure sensor configured to detect air pressure within the door;
a receiver configured to receive a request from a key fob to start or unlock the vehicle; and
a controller programmed to
store the air pressure in response the request, and
after a signal change from the door-ajar sensor, issue an alert based on the stored air pressure prior to the signal change.

16. The vehicle of claim 15 further comprising an atmospheric pressure sensor coupled to the controller and configured to detect atmospheric pressure, wherein the controller is further programmed to issue the alert in response to the air pressure within the door prior to the signal change not varying from the atmospheric pressure by more than an expected amount.

17. The vehicle of claim 16, wherein the expected amount is a predetermined amount that varies as the atmospheric pressure varies.

18. The vehicle of claim 15, wherein the door defines a cavity and the pressure sensor is at least partially disposed within the cavity.

19. The vehicle of claim 18, wherein the pressure sensor is part of an airbag-deployment system in which an airbag is deployed in response to the air pressure in the cavity exceeding a threshold.

20. The vehicle of claim 15, wherein the controller is further programmed to issue the alert by sending a pressure-sensor-error signal to an on-board diagnostic (OBD) connector coupled to an OBD port on the vehicle to cause a diagnostic tool to display the alert.
